(19) United States
(12) Patent Application Publication
(10) Pub. No.: US 2013/0179476 A1
(43) Pub. Date: Jul. 11, 2013

(54) SCALABLE BILLING USAGE DATA STORAGE

(71) Applicants: Christopher Saam, Redmond, WA (US); Marcus Swenson, Duvall, WA (US)

(72) Inventors: Christopher Saam, Redmond, WA (US); Marcus Swenson, Duvall, WA (US)

(73) Assignee: MICROSOFT CORPORATION, Redmond, WA (US)

(21) Appl. No.: 13/346,438

(22) Filed: Jan. 9, 2012

(51) Int. Cl. G06F 17/30

(52) U.S. Cl. 707/803; 707/E17.054

(57) ABSTRACT

An invention is disclosed for scalable billing usage data storage. In an embodiment, users are billed on a monthly cycle. The data storage is divided into two partitions. First, the data is divided into an “L1” partition for each day of the billing cycle. Within each L1 partition, data is further divided into “L2” partitions based on a customer's subscription ID. Through such partitioning, each customer's billing usage data for a billing cycle is entirely contained within a single L2 partition, and that data may be retrieved without spanning partitions.

### BACKGROUND

There are computer systems that process customer billing. Typically, such a billing system will comprise a database that tracks events that result in billable charges (e.g., a long-distance phone call made, or a pay-per-view movie rented), along with the date of the billable event, and an identification of the user who performed the billable event. Such billing databases can become quite large, and this large size may lead to many problems, some of which are well known.

### SUMMARY

One problem with existing billing databases is a problem of scalability. There are databases that address scalability problems by partitioning storage based on the current time by creating a new database each month. New usage data for all subscriptions is then stored in the current month's database. Since billing intervals can start on different days (e.g., one customer's billing interval may start on the 1st of the month, and another customer's billing interval may start on the 8th of the month), a query for a month's worth of billing must often be made across two databases, which requires the use of more processing resources than a query of just one database. Additionally, since the current month's partition carries the entire load of new billing events, this solution does not scale as the number of subscriptions increases.

Another problem with existing billing databases is the “cold start” problem. The cold start problem arises where a switch is made from a very large single active partition to an empty partition, such as with the above database when a new partition is created for a new month. In such a scenario, the storage system must rapidly split pages to accommodate the growth from zero usage data to 100% normal usage data. Performing these page splits causes slow performance at the beginning of each month. In embodiments of SQL SERVER databases, the cold start problem may be mitigated by using an appropriate fill factor, which indicates amount of space on each leaf-level page to be filled with data, with the remainder of each page reserved as free space for future growth. However, using a fill factor does not universally apply to non-SQL storage solutions, like WINDOWS AZURE STORAGE. Additionally, fill factors have a known issue where it will not function if all data is added to the end of a table—which is a common scenario where time is used as part of a row key.

A third problem with existing billing databases is a problem of data archival. Using the above database, removing a partition for a month creates a situation where the following month contains only a partial billing for some users, because their billing cycle is split across the two partitions. There are alternative techniques where data is partitioned by subscription ID (an identifier of a customer). While partitioning by subscription ID improves scalability, data archival remains a problem. Removing aging data requires delete operations to be executed on each partition, which results in thrashing out interleaved data. The thrashing out of interleaved data may cause table and index fragmentation. Fragmentation is generally bad because more input/output (I/O) resources are used to retrieve data in fragmented storage as opposed to retrieving data in defragmented storage.

A fourth problem with known techniques for billing databases is that these known techniques do not support quota detection. That is, known techniques lack a mechanism to detect when a usage level has been reached that is associated with a usage quota for the associated subscription ID that uses a small amount of processing resources. There are techniques for addressing quota detection by performing a runtime computation of the running total for all existing records in a period each time a new billing event is processed. While this technique may work across multiple partitions, there is still a problem that all subscription data must be reprocessed again with each incoming billing event.

Embodiments of the invention address this problem of quota detection by performing an interlocked increment with each billing event insertion. Thus, the running total itself is stored in the database and other billing events do not need to be reprocessed to update quota information. This is not an atomic operation if billing events are spread across multiple partitions, but is an atomic operation in embodiments of the invention. This is an atomic operation in embodiments of the invention because all billing events of the same period are collocated on the same partition, as discussed below.

Embodiments of the present invention address these problems with known techniques for billing databases. Embodiments of the invention are able (1) to have high performance—they may receive and store many thousands of usage events per second; (2) to be massively scalable—they may support the ability to scale out storage resources over time with nearly unlimited scale capacity; (3) to support data archival—they may easily remove aging usage data according to a data-retention policy; and (4) to support quota detection—they allow a performant mechanism to detect whether usage quotas have been exceeded.

In embodiments of the invention, a billing database is implemented using a dual-level partitioning scheme. At the first level, usage data is first partitioned by monthly billing cycle rollover dates (the primary embodiment described herein involves a monthly billing cycle where a billing cycle may begin on the 1st through the 28th day of the month). This partition is described herein as an “L1” or “level one” partition. For example, all subscriptions with bills rolling over on the 10th of the month may be collocated. Each day, a new L1 partition is created, since each day is the start of a new billing interval for 1/28th of the subscription population. At any time, there may then be up to 28 active L1 partition trees.

After L1 partitioning, the billing database is partitioned at a second level (herein “L2” or “level two” partitioning), where the usage data within each L1 partition is further partitioned by subscription ID. The subscription ID may be a unique identifier and sufficiently granular to allow the data to be split across storage nodes as the size of the data set increases. In embodiments, multiple subscription IDs may be stored in one L2 partition, but all billing events for one subscription ID are stored within one L2 partition, unless the amount of billing events for that one subscription ID is too large for a single L2 partition.

### BRIEF DESCRIPTION OF THE DRAWINGS

FIG. 1 depicts an example computer in which embodiments of the invention may be implemented.

FIG. 2 depicts an example system in which embodiments of the invention may be implemented.

FIG. 3 depicts example database tables in which embodiments of the invention may be implemented.

FIG. 4 depicts an example database partitioning in which embodiments of the invention may be implemented.

FIG. 5 depicts example operational procedures that may be used to implement embodiments of the invention.

FIG. 6 depicts an additional example operational procedure that may be used to implement embodiments of the invention.

FIG. 7 depicts additional example operational procedures that may be used to implement embodiments of the invention.

FIG. 8 depicts additional example operational procedures that may be used to implement embodiments of the invention.

### DETAILED DESCRIPTION OF ILLUSTRATIVE EMBODIMENTS

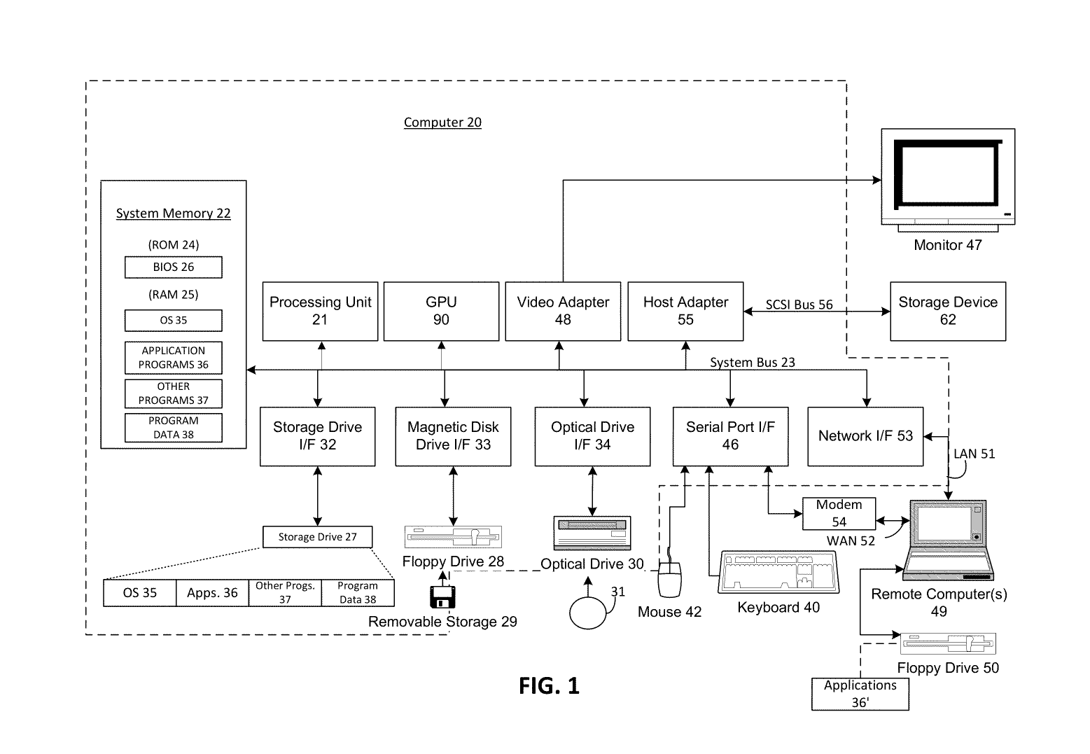

Embodiments of the invention may execute on one or more computer systems. FIG. 1 and the following discussion are intended to provide a brief general description of a suitable computing environment in which embodiments of the invention may be implemented.

FIG. 1 depicts an example general purpose computing system. The general purpose computing system may include a conventional computer 20 or the like, including processing unit 21. Processing unit 21 may comprise one or more processors, each of which may have one or more processing cores. A multi-core processor, as processors that have more than one processing core are frequently called, comprises multiple processors contained within a single chip package.

Computer 20 may also comprise graphics processing unit (GPU) 90. GPU 90 is a specialized microprocessor optimized to manipulate computer graphics. Processing unit 21 may offload work to GPU 90. GPU 90 may have its own graphics memory, and/or may have access to a portion of system memory 22. As with processing unit 21, GPU 90 may comprise one or more processing units, each having one or more cores.

Computer 20 may also comprise a system memory 22, and a system bus 23 that communicative couples various system components including the system memory 22 to the processing unit 21 when the system is in an operational state. The system memory 22 can include read only memory (ROM) 24 and random access memory (RAM) 25. A basic input/output system 26 (BIOS), containing the basic routines that help to transfer information between elements within the computer 20, such as during start up, is stored in ROM 24. The system bus 23 may be any of several types of bus structures including a memory bus or memory controller, a peripheral bus, or a local bus, which implements any of a variety of bus architectures. Coupled to system bus 23 may be a direct memory access (DMA) controller 80 that is configured to read from and/or write to memory independently of processing unit 21. Additionally, devices connected to system bus 23, such as storage drive I/F 32 or magnetic disk drive I/F 33 may be configured to also read from and/or write to memory independently of processing unit 21, without the use of DMA controller 80.

The computer 20 may further include a storage drive 27 for reading from and writing to a hard disk (not shown) or a solid-state disk (SSD) (not shown), a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are shown as connected to the system bus 23 by a hard disk drive interface 32, a magnetic disk drive interface 33, and an optical drive interface 34, respectively. The drives and their associated computer-readable storage media provide non-volatile storage of computer readable instructions, data structures, program modules and other data for the computer 20.

Although the example environment described herein employs a hard disk, a removable magnetic disk 29 and a removable optical disk 31, it should be appreciated by those skilled in the art that other types of computer readable media which can store data that is accessible by a computer, such as flash memory cards, digital video discs or digital versatile discs (DVDs), random access memories (RAMs), read only memories (ROMs) and the like may also be used in the example operating environment. Generally, such computer readable storage media can be used in some embodiments to store processor executable instructions embodying aspects of the present disclosure. Computer 20 may also comprise a host adapter 55 that connects to a storage device 62 via a small computer system interface (SCSI) bus 56.

A number of program modules comprising computer-readable instructions may be stored on computer-readable media such as the hard disk, magnetic disk 29, optical disk 31, ROM 24 or RAM 25, including an operating system 35, one or more application programs 36, other program modules 37, and program data 38. Upon execution by the processing unit, the computer-readable instructions cause actions described in more detail below to be carried out or cause the various program modules to be instantiated. A user may enter commands and information into the computer 20 through input devices such as a keyboard 40 and pointing device 42. Other input devices (not shown) may include a microphone, joystick, game pad, satellite disk, scanner or the like. These and other input devices are often connected to the processing unit 21 through a serial port interface 46 that is coupled to the system bus, but may be connected by other interfaces, such as a parallel port, game port or universal serial bus (USB). A display 47 or other type of display device can also be connected to the system bus 23 via an interface, such as a video adapter 48. In addition to the display 47, computers typically include other peripheral output devices (not shown), such as speakers and printers.

The computer 20 may operate in a networked environment using logical connections to one or more remote computers, such as a remote computer 49. The remote computer 49 may be another computer, a server, a router, a network PC, a peer device or other common network node, and typically can include many or all of the elements described above relative to the computer 20, although only a memory storage device 50 has been illustrated in FIG. 1. The logical connections depicted in FIG. 1 can include a local area network (LAN) 51 and a wide area network (WAN) 52. Such networking environments are commonplace in offices, enterprise wide computer networks, intranets and the Internet.

When used in a LAN networking environment, the computer 20 can be connected to the LAN 51 through a network interface or adapter 53. When used in a WAN networking environment, the computer 20 can typically include a modem 54 or other means for establishing communications over the wide area network 52, such as the INTERNET. The modem 54, which may be internal or external, can be connected to the system bus 23 via the serial port interface 46. In a networked environment, program modules depicted relative to the computer 20, or portions thereof, may be stored in the remote memory storage device. It will be appreciated that the network connections shown are exemplary and other means of establishing a communications link between the computers may be used.

In an embodiment where computer 20 is configured to operate in a networked environment, OS 35 is stored remotely on a network, and computer 20 may netboot this remotely-stored OS rather than booting from a locally-stored OS. In an embodiment, computer 20 comprises a thin client where OS 35 is less than a full OS, but rather a kernel that is configured to handle networking and display output, such as on monitor 47.

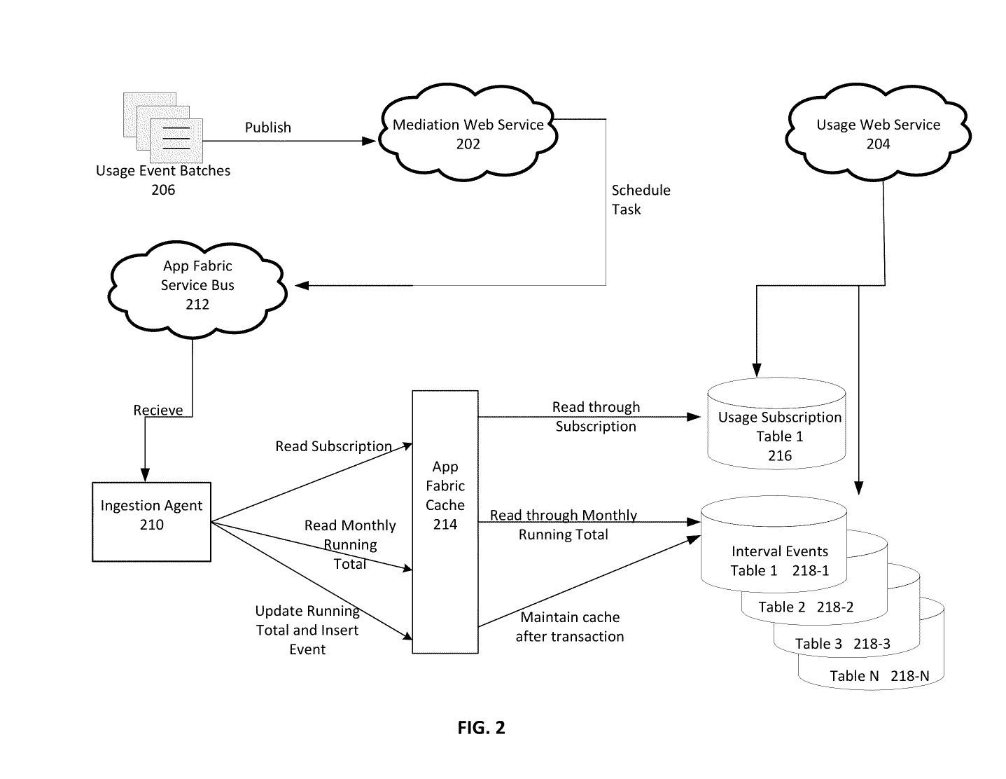

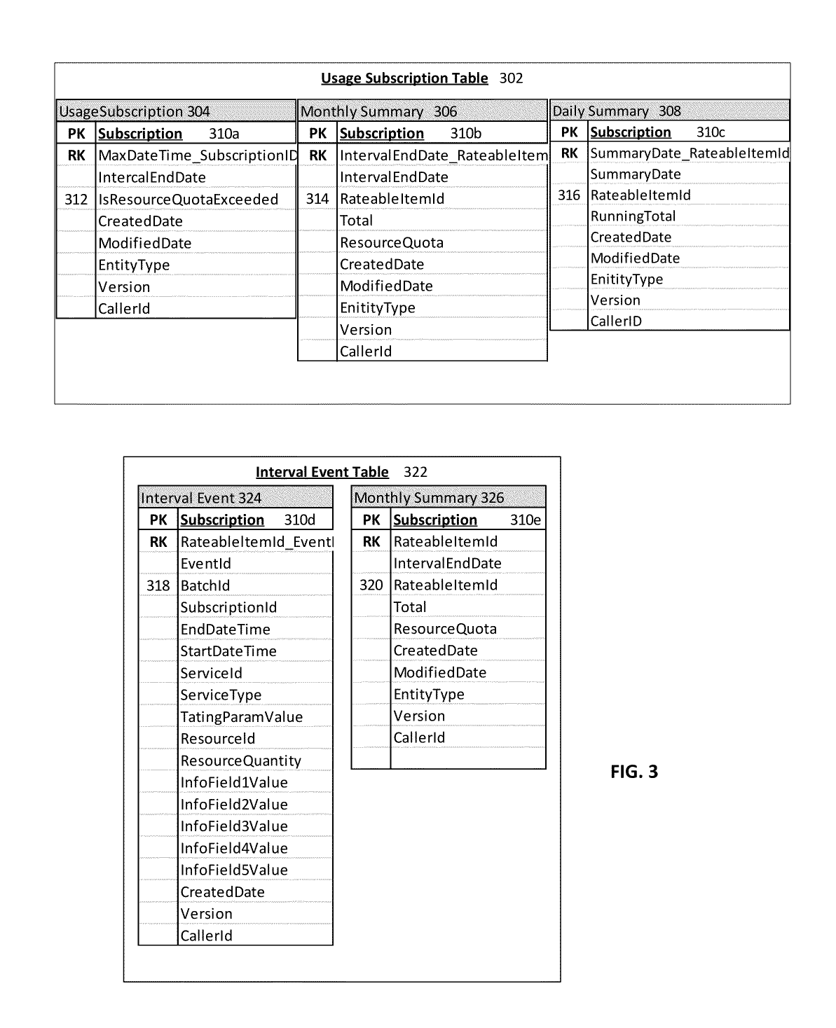

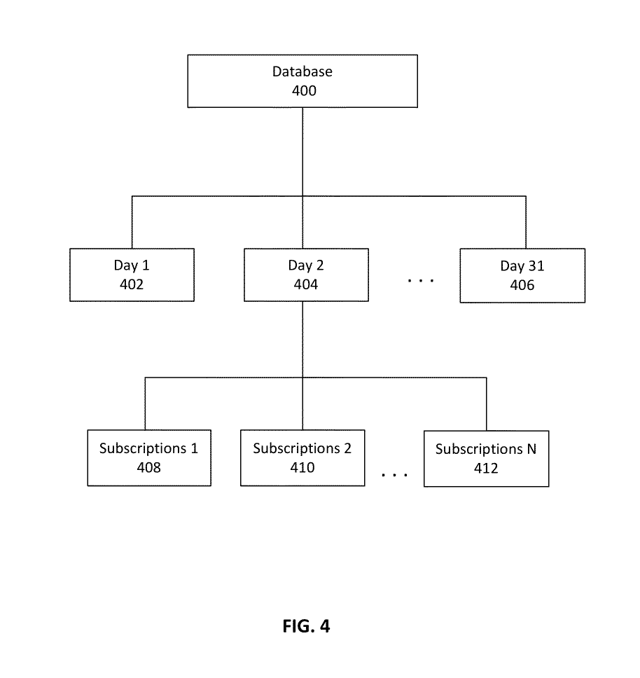

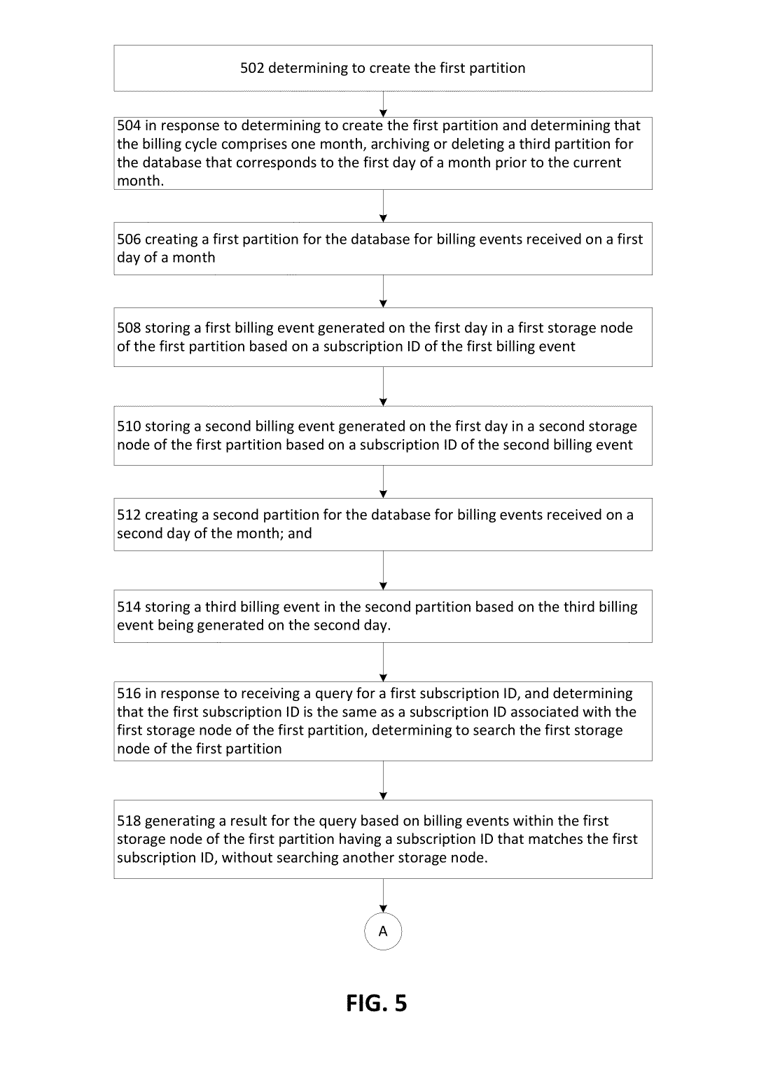

FIG. 2 depicts an example system in which embodiments of the invention may be implemented. Portions of the system in FIG. 2 may be implemented in one or more instances of computer 20 of FIG. 1. The system of FIG. 2 may comprise the database tables of FIG. 3, the database partitioning of FIG. 4, or implement the operational procedures of FIG. 5-8.

FIG. 2 depicts a system comprising a cloud-computing environment (such as versions of the MICROSOFT AZURE cloud-computing environment). As depicted, billing events enter the system through mediation web service 202.

Usage event batches 206 may be published through mediation web service 202. Mediation web service 202 may be invoked by federated services (such as versions of the MICROSOFT AZURE cloud-computing environment) to publish event batches 206. Mediation web service 202 may “shred” the incoming batch 206 into individual events and/or sub-batches, and then schedule them in application fabric service bus 212. Application fabric service bus 212 may receive tasks to be scheduled immediately, or for some future date, and schedules them to be picked up by dispatchers for messaging to worker agents. In embodiments of the invention, application fabric service bus 212 may be WINDOWS AZURE Service Bus.

Ingestion agent 210 (of which there may be multiple instances) may receive tasks from the distributed scheduler via the application fabric service bus 212. The task's usage events may be de-duped and stored while maintaining running totals for cap detection. Ingestion agent may also append as necessary to these fields.

Application fabric cache 214 comprises a distributed cache that may be used to store items that may be maintained in memory with a longevity of the billing period (e.g., one month). Ingestion agent 210 may query application fabric cache to read a subscription or read a monthly total, and to update a running total and insert a billing event. Application fabric cache 214 may generally be used as an optimization to improve performance. There may be embodiments of the invention where application fabric cache 214 is not implemented. In embodiments of the invention, application fabric cache 214 may be WINDOWS AZURE Caching Service.

Usage subscription table 216 comprises a mapping between SubscriptionID and billing cycle date. Usage subscription table 216 may be accessed by bulk subscription processor, view bills, monetary cap enforcer, and EOP.

Interval events tables 218-1, 218-2, 218-3, and 218-4 are partitioned by SubscriptionID, just like usage subscription table 216. In contrast with usage subscription table, a new interval events table 218 may be created each day (or whatever the L1 size is) to correspond to the begin date of each billing interval. A single interval events table may store one month of events for all subscriptions with the same interval end date. Assuming an even distribution of interval end dates, a single interval events table may contain approximately 1/28th of the entire subscription population's events for any given month. In embodiments of the invention, 28 internal events tables are used per month because each month contains at least 28 days (February in a non-leap year having 28 days, while all other months have more than 28 days).

In addition to events, interval events table may contain running total entries for quota detection. Incrementing the running total with idempotency is possible by using group entity transactions and etags (for optimistic concurrency). To maximize scalability throughput, these tables may be created in 30 separate storage accounts, thus enabling 30 times a single storage account's limit of transaction throughput. For instance, where a single storage account has a limit of 5,000 transactions per second, the 30 tables yield a theoretical maximum of 150,000 transactions per second.

FIG. 3 depicts example database tables in which embodiments of the invention may be implemented. In embodiments, usage subscription table 302 may be usage subscription table 216 of FIG. 2, and interval event table 322 may be interval events tables 218-1 through 218-N of FIG. 2. Usage subscription table 302 may be made up of three sub-tables—usage subscription 304, monthly summary 306, and daily summary 308. Each of these sub-tables 304-308 has a partition key of a subscription ID (310a, 310b, 310c). Usage subscription 304 also has RKs 312 of MaxDateTime_SubscriptionID, IntercalEndDate, IsResourceQuotaExceeded, CreatedDate, ModifiedDate, EntityType, Version, and CallerID. Monthly subscription 306 also has RKs 314 of IntervalEndDate RateableItemID, IntervalEndDate, RateableItemId, Total, ResourceQuota, CreatedDate, ModifiedDate, EntityType, Version, and CallerId. Daily summary 308 also has RKs 316 of SummaryDate_RateableItemId, SummaryDate, RateableItemId, RunningTotal, CreatedDate, ModifiedDate, EntityType, Version, and CallerId.

Like user subscription table 302, interval event table 322 is also made up of multiple sub-tables—here, interval event 324 and monthly summary 326. Both interval event 324 and monthly summary 326 have a PARTITION KEY of subscription ID (310d and 310e). Interval event 324 also has RKs 318 of RateableItemId_EventId, EventId, BatchId, SubscriptionId, EndDateTime, StartDateTime, ServiceId, RatingParamValue, ResourceId, ResourceQuantity, InfoField1Value, InfoField2Value, InfoField3Value, InfoField4Value, InfoField5Value, CreatedDate, Version, and CallerId. Monthly summary 326 also has RKs 320 of ReateableItemId, IntervalEndDate, RateableItemId, Total, ResourceQuota, CreatedDate, ModifiedDate, EntityType, Version, and CallerId.

FIG. 4 depicts an example database partitioning in which embodiments of the invention may be implemented. Database 400 stores usage billing data, and may be the interval event tables 218-1 to 218-N of FIG. 2. Database 400 comprises two levels of partitioning—L1 and L2 partitioning, as described above. The L1 partition is a logical partition, whereas the actual data may be stored in the L2 partition storage nodes. In the L1 level, the database is partitioned by day the month, including day 1 partition 402, day 2 partition 404, and day 31 partition 406. There are N partitions at the L1 level for all time because each new day is the start of a new billing cycle partition. The minimum number of days in a month is February (which may have as few as 28 days). In embodiments, there are 28 L1 partitions, and accounts that are opened on the 29th, 30th, or 31st day of a month are assigned a different billing day. In embodiments, there may be 31 L1 partitions, and partitions 29-31 may be left unused for months where there are not that many days.

Each L1 partition is further subdivided into L2 partitions, based on the users' subscription IDs. The L2 partition for the L1 partition of day 2 404 is depicted in FIG. 4. As depicted, the L1 partition of day 2 404 is divided into multiple L2 partitions: subscriptions 1 408, subscriptions 2 410, through subscriptions N 412. Each of these L2 partitions 408-412 is partitioned such that all billing activity for a particular subscription ID and for a particular billing cycle may be stored in a single L2 partition.

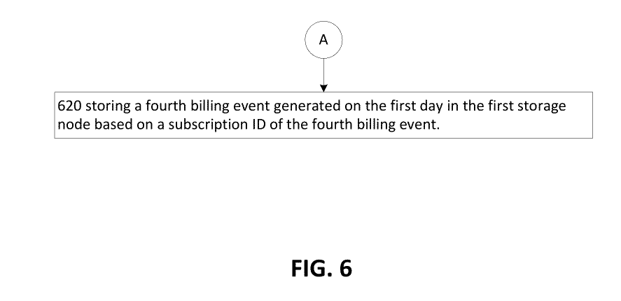

FIG. 5 depicts example operational procedures that may be used to implement embodiments of the invention. In embodiments, the operational procedures of FIG. 5 may be implemented in computer 20 of FIG. 1 to effectuate the system of FIG. 2, including database tables 302 and 322 of FIG. 3, and database 400 of FIG. 4. It may be appreciated that there are embodiments of the invention that do not implement every operation of FIG. 5 (or FIGS. 6-8, and/or that implement the operations of FIG. 5 (or FIGS. 6-8) in a different order than is shown.

Operation 502 depicts determining to create the first partition. This operation may occur, for instance, in response to determining that one day has elapsed since a partition was last created, where one partition is created for each day.

Operation 504 depicts, in response to determining to create the first partition and determining that the billing cycle comprises one month, archiving or deleting a third partition for the database that corresponds to the first day of a month prior to the current month. For instance, the first partition may correspond to the 7th day of the current month. Where this is the case, operation 504 may comprise archiving or deleting the partition corresponding to the 7th day of the previous month. The partition may be archived by removing it from the current database and stored elsewhere, so that there are fewer partitions being maintained in the current database. In embodiments, data may be archived in a similar manner after a longer period of time, such as after one year.

Operation 506 depicts creating a first partition for the database for billing events received on a first day of a month. This may comprise, for instance, creating a new interval events table 218 of FIG. 2. In embodiments, the operation of creating a partition is performed “just-in-time.” When an incoming billing event is to be written to a partition that does not exist, a new partition is created in response to that billing event, and then the billing event may be stored in this new partition. In embodiments, the operation of creating a partition is performed several days before billing events will be stored in that partition. This advanced creation allows time to ensure that the partition is reliably available before that partition's interval begins.

Operation 508 depicts storing a first billing event generated on the first day in a first sub-partition of the first partition based on a subscription ID of the first billing event. This may comprise storing the first billing event in a L2 partition of the database (the L2 partition may be considered a sub-partition relative to the L1 partition). Whereas the first partition contains billing entries for one day, the first partition may further contain a plurality of sub-partitions divided by subscription IDs of users. All billing events for a particular subscription ID within a particular billing cycle may be stored in a given sub-partition. As depicted, the first billing event is associated with a subscription ID, and billing events with that subscription ID are assigned to the first sub-partition of the first partition.

Operation 510 depicts storing a second billing event generated on the first day in a second sub-partition of the first partition based on a subscription ID of the second billing event. The second billing event may have a different subscription ID than the first billing event. While both billing events are both stored in the first partition because they were generated on the first day, they may be stored in different sub-partitions within the first partition, because billing events for one subscription ID are stored in one sub-partition, and billing events for the other subscription ID are stored in another sub-partition.

Operation 512 depicts creating a second partition for the database for billing events received on a second day of the month. Operation 512 may be carried out in a similar manner as operation 504.

Operation 514 depicts storing a third billing event in the second partition based on the third billing event being generated on the second day. Even though the third billing event may have the same subscription ID as the first or second billing events, in embodiments, the partition—the L1 partition, or the day of the billing cycle—takes precedence over the sub-partition within a partition—the L2 partition, or the subscription ID. The third billing event may have the same subscription ID as the first or second billing events in an embodiment where that one subscription ID is associated with multiple billing cycles—one that begins on the first day, and one that begins on the second day.

Operation 516 depicts, in response to receiving a query for a first subscription ID, and determining that the first subscription ID is the same as a subscription ID associated with the first sub-partition of the first partition, determining to search the first sub-partition of the first partition. In embodiments, the database may be queried for billing information, such as a subscription ID's total billing for a month. A query that identifies the first subscription ID may be completed by looking up the billing cycle for that subscription ID in a usage subscription mapping table to identify the sub-partition that contains billing events associated with that subscription ID.

Operation 518 depicts generating a result for the query based on billing events within the first sub-partition of the first partition having a subscription ID that matches the first subscription ID, without searching another sub-partition. In embodiments, since all billing events for a subscription ID are stored within a single sub-partition (there may be, for instance, embodiments where a subscription ID has so many associated billing events that these billing events are divided among a plurality of sub-partitions), such a query may be completed by looking at only one sub-partition, and no others.

In embodiments, the operational procedures of FIG. 5 may end with operation 518. In other embodiments, the operational procedures of FIG. 5 may then flow to one of FIGS. 6-9 where other operational procedures are depicted.

FIG. 6 depicts an additional example operational procedure that may be used to implement embodiments of the invention. In embodiments, the operational procedure of FIG. 6 may be implemented after operation 518 of FIG. 5. Operation 620 depicts storing a fourth billing event generated on the first day in the first sub-partition based on a subscription ID of the fourth billing event. In an embodiment, the fourth billing event may be stored in the first sub-partition (where the first billing event was stored) because both the first and fourth billing events have the same subscription ID. In an embodiment, the first and fourth billing events may have different subscription IDs, but both subscription IDs are assigned to the same sub-partition within the first partition.

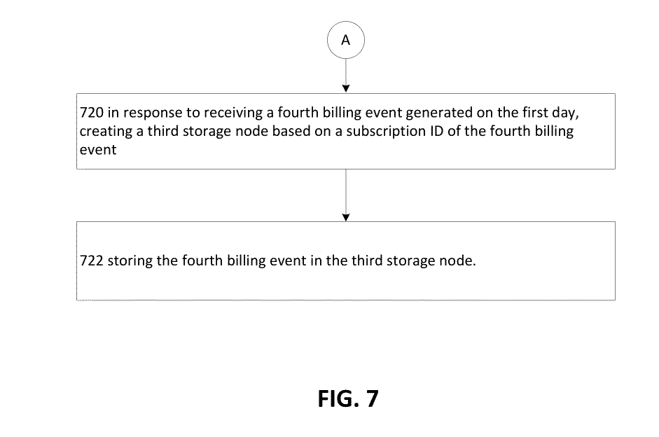

FIG. 7 depicts additional example operational procedures that may be used to implement embodiments of the invention. In embodiments, the operational procedure of FIG. 7 may be implemented after operation 518 of FIG. 5.

Operation 720 depicts, in response to receiving a fourth billing event generated on the first day, creating a third sub-partition based on a subscription ID of the fourth billing event. It may be that the subscription ID of the fourth billing event is different from the subscription IDs of the first and second billing events. It may further be that the subscription ID of the fourth billing event is such that the fourth billing event is neither stored in the first or second sub-partitions of the first partition. In such a case, the fourth billing event may be stored in a third sub-partition of the first partition, and this third sub-partition may be created in operation 720. In embodiments, instead of pre-creating the sub-partitions, sub-partitions are created in response to receiving billing events that prompt their creation. In such embodiments, no extraneous sub-partitions are created, since each sub-partition is created in response to receiving a billing activity that will be stored in that sub-partition.

Operation 722 depicts storing the fourth billing event in the third sub-partition. After the third sub-partition has been created in operation 720, the fourth billing event may be stored in the third storage note as depicted in operation 720.

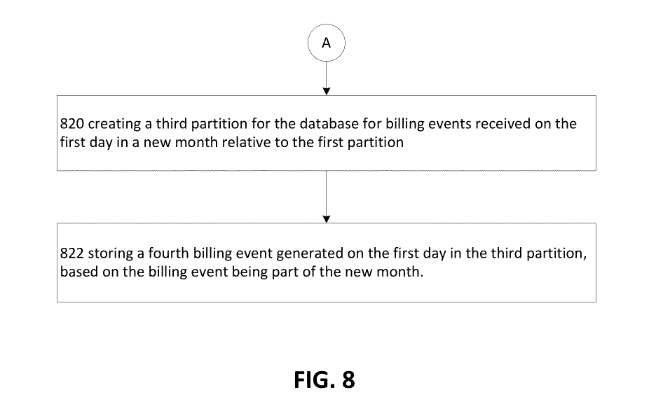

FIG. 8 depicts additional example operational procedures that may be used to implement embodiments of the invention. In embodiments, the operational procedure of FIG. 8 may be implemented after operation 518 of FIG. 5.

Operation 820 depicts creating a third partition for the database for billing events received on the first day in a new month relative to the first partition. For instance, if the first partition is for billings generated for the 7th day in month zero, after the month has ended and the 7th day of month one is reached, the third partition may be created.

Operation 822 depicts storing a fourth billing event generated on the first day in the third partition, based on the billing event being part of the new month. If the billing event were generated in the prior month, it would be stored in the first partition. However, since the billing event is generated in the current month, it is stored in this third partition.

While the present invention has been described in connection with the preferred aspects, as illustrated in the various figures, it is understood that other similar aspects may be used or modifications and additions may be made to the described aspects for performing the same function of the present disclosure without deviating there from. Therefore, the present disclosure should not be limited to any single aspect, but rather construed in breadth and scope in accordance with the appended claims. For example, the various procedures described herein may be implemented with hardware or software, or a combination of both. The invention may be implemented with computer-readable storage media and/or computer-readable communication media. Thus, the invention, or certain aspects or portions thereof, may take the form of program code (i.e., instructions) embodied in tangible media, such as floppy diskettes, CD-ROMs, hard drives, or any other machine-readable storage medium. Likewise, the invention, or certain aspects or portions thereof, may be embodied in propagated signals, or any other machine-readable communications medium. Where the program code is loaded into and executed by a machine, such as a computer, the machine becomes an apparatus configured for practicing the disclosed embodiments. In addition to the specific implementations explicitly set forth herein, other aspects and implementations will be apparent to those skilled in the art from consideration of the specification disclosed herein. It is intended that the specification and illustrated implementations be considered as examples only.

What is claimed:

1. A method for partitioning a database, comprising:
creating a first partition for the database for billing events received on a first day of a month;
storing a first billing event generated on the first day in a first sub-partition of the first partition based on a subscription ID of the first billing event;
storing a second billing event generated on the first day in a second sub-partition of the first partition based on a subscription ID of the second billing event;
creating a second partition for the database for billing events received on a second day of the month; and
storing a third billing event in the second partition based on the third billing event being generated on the second day.

2. The method of claim 1, wherein a billing cycle comprises one month, and further comprising:
before creating the first partition, determining to create the first partition; and
in response to determining to create the first partition and determining that the billing cycle comprises one month, archiving or deleting a third partition for the database that corresponds to the first day of a month prior to the current month.

3. The method of claim 1, further comprising:
storing a fourth billing event generated on the first day in the first sub-partition based on a subscription ID of the fourth billing event.

4. The method of claim 1, further comprising:
storing a fourth billing event generated on the first day in the first sub-partition based on fourth billing event having the subscription ID of the first billing event.

5. The method of claim 1, further comprising:
in response to receiving a fourth billing event generated on the first day, creating a third sub-partition based on a subscription ID of the fourth billing event; and
storing the fourth billing event in the third sub-partition.

6. The method of claim 1, further comprising:
creating a third partition for the database for billing events received on the first day in a new month relative to the first partition;
storing a fourth billing event generated on the first day in the third partition, based on the billing event being part of the new month.

7. The method of claim 1, further comprising:
in response to receiving a query for a first subscription ID, and determining that the first subscription ID is the same as a subscription ID associated with the first sub-partition of the first partition, determining to search the first sub-partition of the first partition; and
generating a result for the query based on billing events within the first sub-partition of the first partition having a subscription ID that matches the first subscription ID, without searching another sub-partition.

8. A system for partitioning a database comprising billing entries with a billing period and a billing unit, the billing period comprising an amount of time for which billing events are collected before being billed, and a billing unit comprising a time within the billing period that a particular subscription ID is billed, comprising:
a processor; and
a memory communicatively coupled to the processor when the system is operational, the memory bearing processor-executable instructions that, when executed on the processor, cause the system to at least:
create a first partition for the database for entries received within a first amount of time, the first amount of time being evenly divisible into the billing unit, or the billing unit being evenly divisible into the first amount of time;
store a first billing event generated during the first billing unit in a first sub-partition of the first partition based on a subscription ID of the first billing event;
store a second billing event generated within the first billing period in a second sub-partition of the first partition based on a subscription ID of the second billing event;
create a second partition for the database for entries received within a second billing unit of the billing period; and
store a third billing event in the second partition based on the third billing event being generated within the second billing period.

9. The system of claim 8, wherein the first amount of time billing unit each comprise one day, and wherein the billing period comprises one month.

10. The system of claim 8, wherein the billing unit is evenly divisible into the billing period.

11. The system of claim 8, wherein the instructions that, when executed on the processor, cause the system to at least create the first partition further cause the system to at least:
create the first partition with a name comprising a name of a deployment of the database, a name of the instance of the database, and an identifier of the first amount of time.

12. The system of claim 8, wherein the memory further comprises processor-executable instructions that, when executed on the processor, cause the system to at least:
create a third partition for the database for billing events received on the first amount of time in a new billing period relative to the first partition;
store a fourth billing event generated on the first day in the third partition, based on the billing event being part of the new month.

13. The method of claim 12, wherein the memory further comprises processor-executable instructions that, when executed on the processor, cause the system to at least:
before creating the third partition, determine to create the third partition; and
in response to determining to create the third partition, archiving or deleting the first partition.

14. A computer-readable storage medium for partitioning a database, bearing computer-readable instructions that, when executed on a computer, cause the computer to perform operations comprising:
creating a first partition for the database for billing events received on a first day of a month;
storing a first billing event generated on the first day in a first sub-partition of the first partition based on a subscription ID of the first billing event;
storing a second billing event generated on the first day in a second sub-partition of the first partition based on a subscription ID of the second billing event;
creating a second partition for the database for billing events received on a second day of the month; and
storing a third billing event in the second partition based on the third billing event being generated on the second day.

15. The computer-readable storage medium of claim 14, wherein a billing cycle comprises one month, and further bearing computer-readable instructions that, when executed upon the computer, cause the computer to perform operations comprising:
before creating the first partition, determining to create the first partition; and
in response to determining to create the first partition and determining that the billing cycle comprises one month, archiving or deleting a third partition for the database that corresponds to the first day of a month prior to the current month.

16. The computer-readable storage medium of claim 14, further bearing computer-readable instructions that, when executed upon the computer, cause the computer to perform operations comprising:
storing a fourth billing event generated on the first day in the first sub-partition based on a subscription ID of the fourth billing event.

17. The computer-readable storage medium of claim 14, further bearing computer-readable instructions that, when executed upon the computer, cause the computer to perform operations comprising:
storing a fourth billing event generated on the first day in the first sub-partition based on fourth billing event having the subscription ID of the first billing event.

18. The computer-readable storage medium of claim 14, further bearing computer-readable instructions that, when executed upon the computer, cause the computer to perform operations comprising:
in response to receiving a fourth billing event generated on the first day, creating a third sub-partition based on a subscription ID of the fourth billing event; and
storing the fourth billing event in the third sub-partition.

19. The computer-readable storage medium of claim 14, further bearing computer-readable instructions that, when executed upon the computer, cause the computer to perform operations comprising:
creating a third partition for the database for billing events received on the first day in a new month relative to the first partition;
storing a fourth billing event generated on the first day in the third partition, based on the billing event being part of the new month.

20. The computer-readable storage medium of claim 14, further bearing computer-readable instructions that, when executed upon the computer, cause the computer to perform operations comprising:
in response to receiving a query for a first subscription ID, and determining that the first subscription ID is the same as a subscription ID associated with the first sub-partition of the first partition, determining to search the first sub-partition of the first partition; and
generating a result for the query based on billing events within the first sub-partition of the first partition having a subscription ID that matches the first subscription ID, without searching another sub-partition.
